(19) United States
(12) Patent Application Publication
(10) Pub. No.: US 2013/0226682 A1
(43) Pub. Date: Aug. 29, 2013

(54) PERSON-TO-PERSON TRANSACTION IDENTIFICATION OF COUPONS AND LOYALTY CARDS

(71) Applicant: Glenn Grossman, Matthews, NC (US)

(72) Inventor: Glenn Grossman, Matthews, NC (US)

(73) Assignee: BANK OF AMERICA CORPORATION, Charlotte, NC (US)

(21) Appl. No.: 13/407,547

(22) Filed: Feb. 28, 2012

(51) Int. Cl. G06Q 30/02

(52) U.S. Cl. 705/14.23

(57) ABSTRACT

Embodiments of the invention are directed to a system, method, or computer program product for loyalty identification matching during a person-to-person transaction. Embodiments of the invention reduce the friction of enrolling in and providing loyalty accounts and coupons during a person-to-person transaction with a person, merchant, and/or other entity. Once the user enrolls in the program, all loyalty accounts the user may have are determined. Furthermore, coupons that are available to the user are determined and stored in association with the user's loyalty accounts. In this way, the user may provide his/her person-to-person alias ID to initiate a person-to-person transaction. This same alias ID may also allow the user to utilize his/her loyalty accounts and/or coupons for the transaction. The system, after receiving the alias ID may provide the other party of the person-to-person transaction with all loyalty accounts and coupons associated with the transaction.

### BACKGROUND

An individual regularly receives promotional offers, coupons, loyalty rewards, and/or the like in order to entice an individual to shop at a particular merchant or location. These offers may come to the individual through the mail, email, the Internet, the newspaper, flyers, and the like. Most of the time the offers received by the individual go unused. This may be because the individual does not take the time to cut-out or print-off the offer, find an offer that he/she wants to use, cuts-out the offer but fails to use it, or the individual may not even look at the offers he/she receives.

The individuals that do take the time to look through all the offers they receive and utilize the offers at merchants tend to save significant amounts of money on transactions for products that are associated with the offers. The offers provided for products may add up to substantial savings for the individuals that take advantage of the offers that they receive.

However, typically the offers that an individual may use are few in comparison to the amount of offers that are potentially available for a product, brand of product, or type of product. For example, an individual may receive a coupon in a newspaper, cut out the coupon and use it to purchase a product. However, there may be other promotional offers that the individual may not be aware of, such as a promotional offer on the Internet that may be a better deal for the individual. In this way, the individual may miss a promotional offer, because he/she was unable to find the offer.

Therefore, a need exists for individuals to be able to find and utilize offers without having to search for, cut-out, and bring with him/her to the merchant in order to receive the benefit of the offer.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product and/or other devices) and methods for providing loyalty identification and coupon matching for a user. Thus, loyalty accounts and coupons may be utilized by a user during a person-to person (P2P) transaction using a simple identification of the user.

In some embodiments, the system may receive an indication that a user may wish to enroll in the loyalty identification matching program. The user may enroll by manually providing the system with enrollment information. The user may also enroll automatically based on the user's prior enrollment in other programs provided by merchants, financial institutions, and/or other entities that may be providing the loyalty identification matching program. Other programs may include P2P transaction programs and/or the like.

Next, the system may receive user enrollment data from the user which may include the user identifier, such as his/her P2P alias. Furthermore, the system may determine all of the loyalty accounts the user currently has. In this way, the system may determine the loyalty accounts by user provided data, by communicating with merchants, and/or the like.

In some embodiments, the system may then populate the user's loyalty database with all the loyalty accounts that the system has determined are associated with the user. The user's loyalty accounts are determined by the user's enrollment information and the system communicating with several merchants to determine the loyalty accounts associated with the user.

In some embodiments, once all of the user's loyalty accounts are stored with the user enrollment data the system may determine coupons the user may be able to utilize for transactions with merchants the user has loyalty accounts with via a P2P transaction. In this way, the system may receive coupons from merchants, user inputted coupons, manufacturers, advertisers, etc. and tie the coupons to the loyalty accounts the user has. In some embodiments, the coupons are based on the loyalty accounts the user has. In other embodiments, the coupons are based on the products the user is transacting with a merchant to purchase.

In some embodiments, the system may provide a merchant with the user's loyalty account and coupons in response to the user providing the merchant with a user identifier, such that the transaction may incorporate the user's loyalty account and/or coupons. In this way, the user may be able to provide a simple user identifier without having to provide a loyalty account card, cut-out coupons, or the like to utilize his/her loyalty account and/or coupons. In this way, the invention reduces friction associated with the user having to enroll in and utilize loyalty accounts by providing keychain cards, etc. to the merchant.

In some embodiments, if the user is attempting to transact with a merchant that the user does not have a loyalty account with, the system may offer the user automatic enrollment in the loyalty account associated with the merchant the user is attempting to transact with. In this way, the user may be able to automatically enroll in loyalty accounts and utilize coupons that the user may not have been able to utilize for that transaction because he/she was not a loyalty account holder for that merchant.

Embodiments of the invention relate to systems, methods, and computer program products for providing loyalty account information during a person-to-person transaction, comprising: receive a user alias identification from a user, wherein the user is initiating a person-to-person transaction with a second party utilizing the user alias; determine loyalty accounts associated with the user, wherein the loyalty accounts are determined by communicating with merchants providing the loyalty accounts, wherein the loyalty accounts are stored in association with the user alias identification; determine an alias identification for the second party of the person-to-person transaction; determine if the loyalty accounts associated with the user alias identification received from the user are accepted by the entity associated with the alias identification for the second party of the person-to-person transaction; and provide the second party of the person-to-person transaction with the loyalty accounts accepted by the second party of the person-to-person transaction, such that the loyalty accounts can be applied to the person-to-person transaction.

In some embodiments, the invention further comprises: determining coupons available to the user; storing the coupons in association with the user identifier and the loyalty accounts; determining coupons that the second party of the person-to person transaction accepts; and providing the second party with the coupons acceptable by the second party in association with the loyalty accounts accepted by the second party, such that the coupons and loyalty accounts can be applied to the transaction with the second party.

In some embodiments, the user alias identification is associated with a financial account of the user, such that the financial account is used for payment to the second party in the person-to-person transaction.

In some embodiments, the invention further comprises processing the person-to-person transaction such that a payment is transferred from the financial account associated with the user alias identification to a financial account associated with the second party of the person-to-person transaction. In some embodiments, the second party is a receiver of a person-to-person payment made by the user via the person-to-person transaction, wherein the second party is a merchant.

In some embodiments, determining loyalty accounts associated with the user further comprises one or more of automatically determining the loyalty accounts associated with the user upon user enrollment into a person-to-person transaction program or receiving loyalty account information from the user. In some embodiments, determining coupons available to the user further comprises one or more of receiving coupons from a merchant offering the coupons or receiving coupons from the user.

In some embodiments, the invention further comprises providing automatic enrollment in one or more loyalty accounts associated with the second party of the person-to-person transaction if no loyalty accounts associated with the user alias identification are accepted by the second party.

In some embodiments, the person-to-person transaction is one or more of a person-to-person, person-to-merchant, or person-to-entity transaction.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a loyalty identification matching program process, in accordance with one embodiment of the present invention;

FIG. 2 provides a loyalty identification matching program system environment, in accordance with one embodiment of the present invention;

FIG. 3 provides a combination flowchart and block diagram of a system and method for making P2P payments, in accordance with one embodiment of the present invention;

FIG. 4 provides a block diagram illustrating the various ways through which a user may make P2P payments, in accordance with one embodiment of the present invention;

FIG. 5 provides a process map illustrating the population of the loyalty identification matching program system, in accordance with one embodiment of the present invention;

FIG. 6 provides a process map illustrating populating of the loyalty identification matching program system, in accordance with one embodiment of the present invention;

FIG. 7 provides a process map illustrating the loyalty identification matching program being used for a person-to-person transaction, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Furthermore, as used herein, the term “product” shall mean any good, service, event, etc. that may be offered by an advertiser. In addition, the term “offer” or “promotional offer” is used herein to denote any form of offer, promotion, rebate, coupon, incentive, sale event, and/or the like offered for the purchase, lease, and/or the like of a product. A “merchant” as used herein may refer to an advertiser, manufacturer, retailer, merchant, service provider, event provider, warehouse, supplier, commercial partner of a financial institution, and/or the like.

Although some embodiments of the invention herein are generally described as involving a “financial institution,” one of ordinary skill in the art will appreciate that other embodiments of the invention may involve other businesses that take the place of or work in conjunction with the financial institution to perform all of the processes or steps described herein as being performed by a financial institution. Still in other embodiments of the invention the financial institution described herein may be replaced with other types of businesses that are in the position to provide loyalty identification matching.

Embodiments of the present invention provide a system and method for utilizing an a loyalty identification matching program for integration into P2P payments. Embodiments of the invention allow users to make payments directly from their accounts, whether their accounts be checking, savings, line of credit, credit card, stock, and/or other accounts, to a payment receiver. In some embodiments, the user and/or payment receiver may be customers of the financial institution providing the loyalty identification matching program and/or the P2P system. In some embodiments, the user and/or receiver may not be customers of the financial institution providing the loyalty identification matching and/or the P2P system. The system further allows transfer of funds from a user to a receiver without sharing any confidential account information and without knowing account information for the intended payment receiver. In some embodiments, the users may not currently be customers of the financial institution providing the P2P payment option, but may wish to use the P2P system to make payments to other entities. These users may access their accounts from other financial institutions to provide payment via P2P. In this way, the user may access accounts from other financial institutions to make payments through the P2P system. Embodiments of the invention also allow users to utilize loyalty accounts and/or coupons accepted by the receiver of the P2P payment during the P2P transaction without requiring the user to share any information with the payment receiver. The system, based on receipt of the user identifier, or alias, may provide the payment receiver with all the user's loyalty account and coupon information.

It should be noted that some embodiments of the invention allow a user to make payments to and/or receive payments from a merchant in the same way that a user can make payments to and/or receive payments from an individual. As such, as used herein, the phrase person-to-person (P2P) is intended to include person-to-merchant (P2M), merchant-to-merchant (M2M), and merchant-to-person (M2P) unless specifically stated otherwise. Moreover, embodiments of the present invention permit a sender to send money from the sender's financial institution account directly to the receiver's financial institution account either by selecting a pre-established receiver from a data repository or providing an alias receiver such that the receiver account information may be determined by the data repository from information inputted by the user. This allows for greater security as no party apart from the sender, the receiver, and the bank is ever a part of the transfer.

It should be appreciated that at least some embodiments of the invention provide a more convenient, user friendly, and secure P2P payment system because it allows a user to utilize his/her loyalty accounts and/or coupons during a P2P transaction.

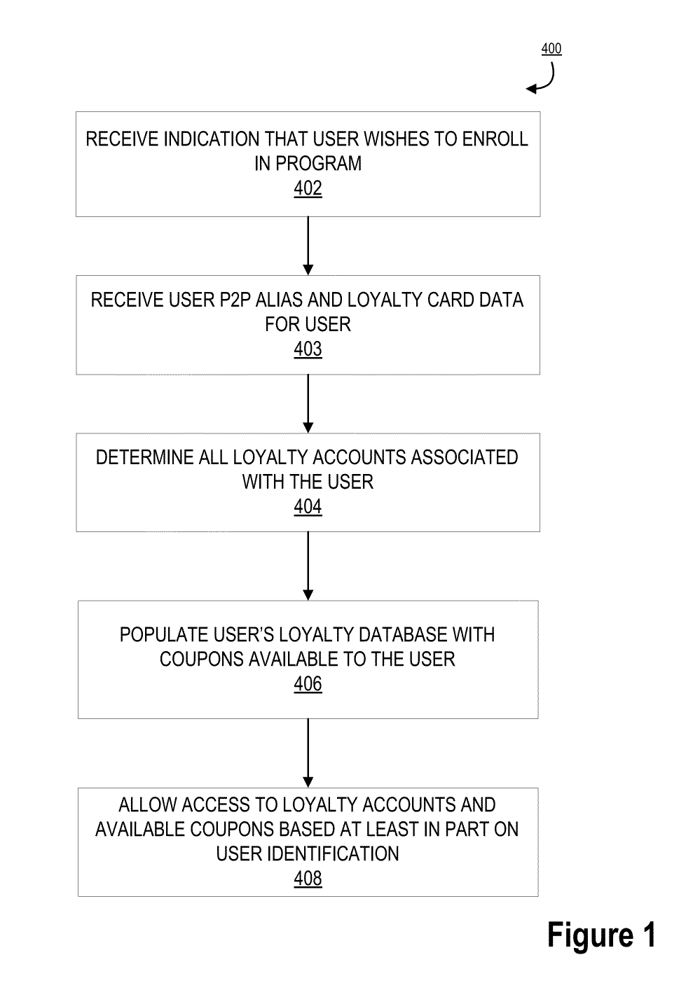

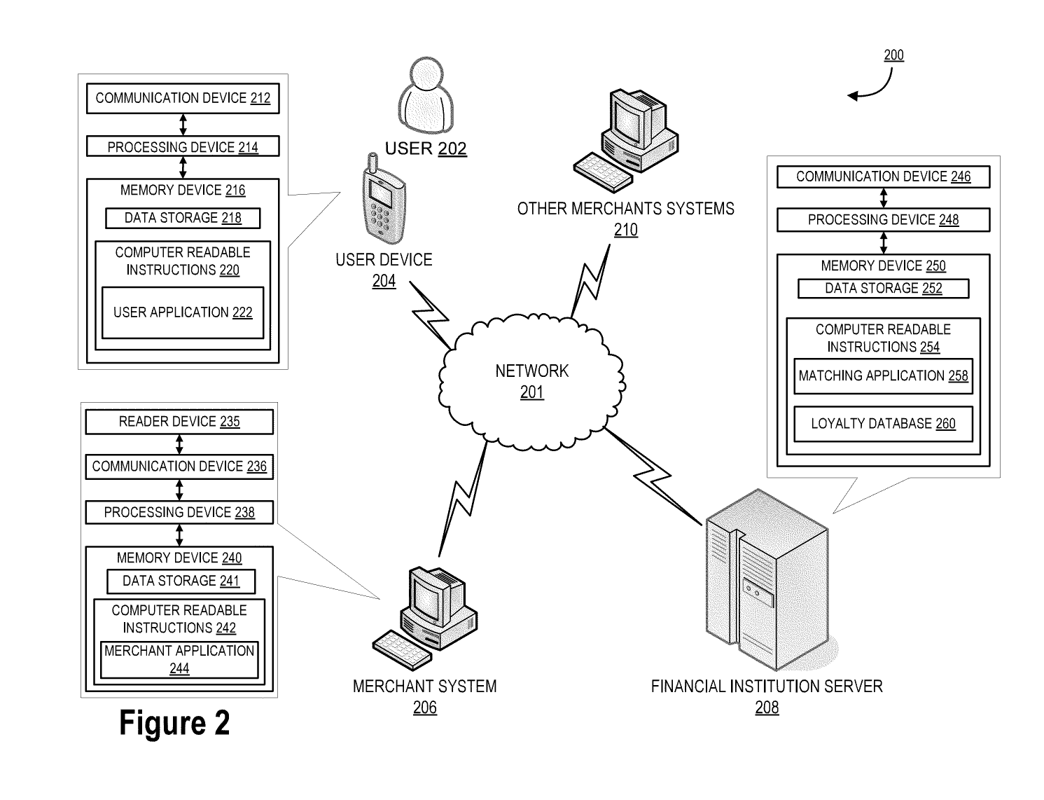

FIG. 1 illustrates a high level process flow for the loyalty identification matching program 400, which will be discussed in further detail throughout this specification with respect to FIGS. 2 through 7. The first step in the process 400 is to receive an indication that the user wishes to enroll in the loyalty identification matching program for P2P transactions, as illustrated in block 402. In some embodiments, the enrollment may be initiated by the user. In other embodiments, the enrollment may be initiated by the program. The next step in the process 400 is to receive the user's P2P alias and loyalty card data for the user 403. In some embodiments, the system may access and acquired the user's P2P alias and loyalty card data independent of user input. Loyalty card data may include any data that a merchant or other entity may require in order for a user to set up and activate a loyalty account with the merchant, this data may include, but is not limited to a user's telephone number, alias, address, financial data, birth date, etc. In this way, the system may have access to information about the user, such as his/her telephone number, address, etc. that may be included as loyalty card data, based on other programs the user may have with the entity providing the program.

Next, in block 404, the system determines all the loyalty accounts associated with the user. In some embodiments, the loyalty accounts associated with the user may be determined from the system communicating with merchants providing loyalty accounts. In this way, the system may reach out to merchants that provide loyalty accounts and determine all of the merchants that the user has loyalty accounts with. In other embodiments, the loyalty accounts associated with the user may be determined by user inputs. In this way, the user may provide information associated with the loyalty accounts the user has with various merchants. Once the system has determined all the loyalty accounts associated with the user and stored the information in a user director, the system may populate the user's loyalty accounts located within the directory with coupons available to the user, as illustrated in block 406. In this way, coupons available to the user may be accessed via the user's loyalty account. For example, if a user is transacting with a merchant, the user may present his/her loyalty card. The loyalty card may be scanned by the merchant to associate the transaction with the user's loyalty account. By populating the loyalty account associated with the user with coupons, these coupons may be automatically applied to the user's transaction at the merchant. In this way, the user may not have to provide cut-out, printed, etc. coupons at the point-of-transaction, but instead just provide the loyalty account. The loyalty account may store the coupons and provide them to the merchant at the point of transaction. Finally, as illustrated in block 408 the system allows a merchant to gain access to the user's loyalty account and the coupons stored therewith based on the user provided identification. The user provided identification may include the user's phone number, P2P alias ID, PIN number, code, password, etc. In this way, the user does not have to provide a keychain card, loyalty card, loyalty account number, etc. during a P2P transaction, but instead only provide the system and the P2P payment receiver with a user identification, such as a telephone number and/or the user's alias ID.

FIG. 2 provides a loyalty identification matching program system environment 200, in accordance with one embodiment of the present invention. As illustrated in FIG. 2, the financial institution server 208 is operatively coupled, via a network 201 to the user device 204, to a merchant system 206, and to other merchants systems 210. In this way, the financial institution server 208 can send information to and receive information from the user device 204, the merchant system 206, and to other merchant systems 210 to allow a user 202 to enroll in the loyalty identification matching program, collect enrollment information from the user 202, populate the loyalty accounts and user 202 enrollment data into a user loyalty database, match coupons to the users database, provide user 202 identify confirmation to a merchant, and provide loyalty and coupon data for a transaction. FIG. 2 illustrates only one example of an embodiment of a loyalty identification matching program system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The individual may be an account holder at the financial institution or not associated with the financial institution. The individual may wish to purchase products using P2P payments, such as at a merchant, on-line, via a virtual shopping board, and/or the like, utilizing the loyalty accounts provided to the individual from a merchant or P2P payment receiver.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are located between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the user device 204, the merchant system 206, and the other merchants systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a matching application 258. In another embodiment, the computer-readable instructions 254 stored in the memory device 250 includes the computer-readable instructions 254 of a loyalty database 260. In some embodiments, the memory device 250 includes data storage 252 for storing data related to the financial institution including but not limited to data created and/or used by the matching application 258, and/or the loyalty database 260.

In the embodiment illustrated in FIG. 2 and described throughout much of this specification, the matching application 258 allows for user 202 enrollment, collection of data, matching of data, matching of user 202 identification, confirmation of user's identification, and delivery of loyalty and/or coupons to a merchant system 206 and/or other merchants systems 210.

In some embodiments, the matching application 258 allows for user 202 to enroll into the loyalty identification matching program for P2P transactions. A user 202 may enroll in several ways, including, but not limited to manual enrollment, automatic enrollment, secondary enrollment based on enrollment in other programs, and/or the like. In some embodiments, the matching application 258 may allow a user 202 to enroll into the loyalty identification matching program by inputting his/her information into an enrollment form. The enrollment form may be accessed through the user's online banking, mobile banking, the Internet, at a merchant, at a financial institution, and/or the like. The user 202 may complete the enrollment form using his/her user device 204, hand writing etc. In other embodiments, the user 202 may automatically be enrolled in the loyalty identification matching program. In this way, the matching application 258 may recognize that the user 202 is an account holder at the financial institution, is a loyalty account holder with a merchant, is involved in a coupon program, is involved in a P2P payment program, and/or another merchant or financial institution program. In this way, the matching application 258 may determine information required to enroll the user 202 in the loyalty identification matching program from accessing the other programs the user 202 is enrolled in, such as the P2P payment program. In some embodiments, whether manually or automatically, the user 202 may select to opt-in to enroll in the loyalty identification matching program prior to the matching application 258 enrolling the user 202 and populating the user's loyalty database 260 with the user's enrollment data.

Whether manually or automatically, the matching application 258 may receive enrollment data from the user 202 and/or the other programs the user 202 is enrolled in, such that he/she may be enrolled in the loyalty identification matching program. The enrollment data may include, but is not limited to, the user's name, address, telephone number, loyalty account information, family member information, P2P alias ID, and/or the like.

In some embodiments, the matching application 258 matches information collected from the user 202 with loyalty accounts the user 202 may have. The matching application 258, using the enrollment data, may communicate with the merchant system 206 and other merchant systems 210 to determine all loyalty accounts the user 202 may have with various merchants, entities, businesses, other individuals, etc. In this way, the matching application 258 may determine all of the loyalty accounts that the user 202 may be associated with, without the user 202 having to provide all of the user's loyalty accounts and the numbers and/or bar codes associated therewith. The matching application 258 may determine, from the enrollment data each of the one or more loyalty accounts that a user 202 may be enrolled in.

Furthermore, the matching application 258, again using the user 202 information from enrollment may also be able to determine other programs, such as coupon programs, discount programs, rewards programs, etc. that the user 202 may also be enrolled in.

Once the matching application 258 determines the user 202 information, collects all the loyalty accounts associated with the user 202, and determines other programs the user 202 is associated with, the matching application 258 may populate the user's loyalty database 260 with all of this information. As such, the matching application 258 may the various data to the user, such that the user's enrollment data may be associated with his/her loyalty accounts, and other programs in the loyalty database 260. For example, if the matching application 258 determines that a user 202 has a loyalty card with Merchant A, Merchant B, and Merchant D, the matching application 258 may determine that the user 202 has these loyalty cards by communicating with the systems associated with Merchant A, Merchant B, and Merchant D. The matching application 258 may then associate the loyalty accounts found for the user 202 with the user 202 loyalty database 260 associated with the user's enrollment data and other programs associated with the user 202.

Once the user's enrollment data and loyalty accounts are stored in the user loyalty database 260, the matching application 258 may associate any coupons that the user 202 may have access to with the user 202 information and loyalty accounts stored in the user's loyalty database 260. The matching application 258 may determine the coupons available for the user 202 in several ways, including but not limited to, automatically adding coupons, allowing the user 202 to manually add coupons, merchant added coupons, etc. Once the coupons are added to the user loyalty database 260, the user 202 may be able to make a transaction using a loyalty account and the coupons stored in association with that loyalty account may also be used for that transaction. In this way, the user 202 may not have to bring the coupons to the store, but instead may present the user's loyalty account to the merchant to be able to utilize the coupons. In some embodiments, the user 202 may be able to add coupons to his/her loyalty database 260 via his/her user device 204, the Internet, mobile application, etc. In some embodiments, the merchant application 258 may automatically provide the user's loyalty database 260 with coupons. For example, if the user 202 is associated with a coupon program or the like, the coupons from the coupon program may be automatically provided to the user's loyalty database 260. In other embodiments, coupons may be added to the user's loyalty database 260 by a merchant. In this way, the merchant may provide the matching application 258 with the coupons it has to offer users 202 and store them with the user's enrollment data and loyalty accounts in the loyalty database 260. In this way, when a user 202 uses his/her loyalty account, coupons that are stored with the loyalty account for that user 202 may be used for that transaction.

Once the matching application 258 has populated a user's loyalty database 260 with the user's enrollment data, loyalty accounts, and coupons, the matching application 258 may receive communications from a merchant system 206 that a user 202 may be transacting with. The user 202 may provide the merchant with identification, such as a user 202 identifier. This identification may be substituted for the user 202 presenting a loyalty card, keychain card, loyalty account, paper coupon, coupon code, QR code, bar code, etc. to the merchant during a P2P transaction. Instead, the user 202 may provide a user 202 identifier, such as, but not limited to the user's phone number, P2P alias ID, PIN number, code, password, etc. to the merchant. The merchant may then communicate the user 202 identifier to the matching application 258. The matching application 258 may match the user 202 identifier with the user's enrollment data provided to the matching application 258 when the user 202 enrolled in the program. If there is a match between the user 202 identifier and the user's enrollment data stored in the loyalty database 260, the matching application 258 may confirm that the user 202 identifier is associated with the specific user 202 initiating a transaction with a merchant.

Once a merchant system 206 sends the user 202 identifier to the matching application 258 and the user 202 identifier is confirmed, the matching application 258 may search the user's loyalty database 260 to determine the loyalty accounts and/or coupons that the user 202 may be able to utilize for a transaction with the merchant. For example, if the matching application 258 receives a user 202 identifier from a merchant system 206 associated with Merchant A that the user 202 is conducting a P2P transaction with, the matching application 258 will search the user's database 260 for any loyalty accounts and/or coupons that Merchant A will accept. Furthermore, the matching application 258 may also search for all coupons associated with products the user 202 is purchasing during the P2P transaction. These coupons may be coupons that the user 202 has provided to his/her loyalty database 260, merchant provided coupons, other merchant provided coupons, manufacturer provided coupons, and/or the like. In this way, the matching application 258 may determine all coupons for the products the user 202 is currently purchasing. For example, if the merchant accepts coupons from other merchants for specific products the matching application 258 may determine, in real-time, the products the user 202 is purchasing and whether there are coupons available for that product. Therefore, when the user completes the P2P transaction, all coupons that the user 202 may be able to use for the products he/she is purchasing may be utilized.

The matching application 258 may then communicate the user's loyalty account and coupons back to the merchant system, such that the user's current transaction with the merchant may incorporate his/her loyalty account and coupons into the transaction. In this way, the user 202 does not have to provide the merchant with his/her loyalty card or coupons, but instead, may just provide the merchant with his/her user 202 identifier, such as an alias ID, during the P2P transaction. Typically, for a P2P transaction to be used, the user 202 may have to provide the payment recipient or merchant with his/her alias ID anyway. Therefore, using the loyalty identification matching program may be done without any additional inputs by the user 202. The merchant system 206 may then communicate with the matching application 258 via a network 201. This communication allows the matching application 258 to provide the merchant system 206 with all loyalty accounts and coupons associated with the merchant and/or the products the user 202 is currently transacting. In this way, the user 202 may present his/her alias ID to initiate a P2P transaction. The user 202 may then provide the merchant or payment recipient's P2P alias ID to initiate a transaction with that merchant or recipient. The merchant system 206 may communicate the user's alias ID to the matching application 258. The matching application 258 may then associated the user's alias ID with the loyalty accounts and coupons on the loyalty database 260. The matching application 258 may then communicate the loyalty accounts and coupons back to the merchant system 206 to be incorporated into the transaction the user 202 is entering into. This way, the loyalty accounts and/or coupons may be accounted for and utilized in association with the transaction the user 202 is currently entering with a merchant.

Furthermore, if the matching application 258 receives a user 202 identifier from a merchant that, after searching the loyalty database 260, it is determined that the user 202 matching that user 202 identifier does not have any loyalty accounts and/or coupons that correspond to that merchant the matching application 258 may offer the user 202 to enroll in that merchant's loyalty account. In some embodiments, the user 202 may be offered enrollment via his/her user device 204. In other embodiments, the user 202 may be automatically enrolled. In this way, the matching application 258 may be able to automatically enroll the user 202 in a loyalty account associated with that merchant by utilizing the user's enrollment data that the matching application 258 received when the user 202 enrolled in the loyalty identification matching program. Utilizing this information, the matching application 258 may provide the merchant system 206 the necessary information, such as the user's name, phone number, etc. that may be required by the merchant to enroll in their loyalty program. The user 202 may then be able to receive a loyalty account with that merchant and be able to utilize that loyalty account during his/her current purchase.

In other embodiments of the invention, the matching application 258 may be configured to provide loyalty accounts and/or coupons for user 202 transactions via P2P. In this way, a user 202 may be able to send and receive payments via P2P while also getting the benefits of utilizing loyalty accounts and/or coupons. The P2P payment method uniquely allows the payment sender to not know any information about the financial accounts of the intended payment receiver or vise-versa. In this way, P2P payment allows a user 202 to transfer money to individuals, entities, etc. without having to exchange any personal information.

In this embodiment of the invention, the matching application 258 allow users 202 to make payments directly from their accounts, whether their accounts be checking, savings, line of credit, credit card, stock, and/or other accounts, to a payment receiver. P2P payments further allow for the transfer of funds from a user 202 to a receiver without sharing any confidential account information and without knowing account information for the intended payment receiver. In this way an alias is used. The alias is a name or number associated with the payment recipient. The user 202 providing the payment may simply select the intended payment recipient's alias. The transaction will be completed by a financial institution that knows the account associated with that alias. It should be noted that P2P payments allow a user 202 to make payments to and/or receive payments from a merchant in the same way that a user 202 can make payments to and/or receive payments from another person.

As further illustrated in FIG. 2, the financial institution server 208 further comprises a loyalty database 260. The loyalty database 260 may store any user 202 information, loyalty accounts, and/or coupons. The loyalty database 260 stores this information stores all of the data collected for a user 202 together. This way, the loyalty database 260 knows the user's identifier and may quickly access all data associated with that user 202 based on the identifier.

In some embodiments, the loyalty database 260 stores user 202 information, such as enrollment data. The enrollment data stored in the loyalty database 260 may include, but is not limited to, the user's name, address, telephone number, loyalty account information, family member information, P2P alias ID, and/or the like. The loyalty database 260 may also store the user 202 identifier associated with the user 202. The user 202 identifier may be the user's P2P alias ID, telephone number, a PIN number, code, password, etc. The user 202 identifier may be one of the ways the loyalty database 260 for a user 202 is searched for and found. For example, when the matching application 258 receives a user 202 identifier from a merchant system 206, the matching application 258 searches the loyalty database 260 to find the user 202 associated with that user 202 identifier. The user 202 identifier provided by the merchant system 206 may have been received at the merchant system 206 by a user 202 transacting with that merchant.

In some embodiments, the loyalty database 260 stores loyalty accounts associated with the user 202. Based on the user 202 information received during enrollment the matching application 258 may communicate with merchants providing a loyalty account program. The matching application 258 may determine all of the loyalty accounts the user 202 has previously enrolled in for all merchants providing a loyalty account program. These loyalty accounts may then be stored associated with the user 202 in the loyalty database 260. The loyalty accounts may include bar codes, account numbers, QR codes, and/or the like that a merchant may use to identify the loyalty account during a transaction.

In some embodiments, the loyalty database 260 stores coupons associated with the user 202. Coupons may be added to the loyalty database 260 in several ways, including but not limited to, automatically adding coupons, allowing the user 202 to manually add coupons, allowing merchants added coupons, etc. In some embodiments, the user 202 may be able to add coupons to his/her loyalty database 260 via his/her user device 204, the Internet, mobile application, etc. In some embodiments, the merchant application 258 may automatically provide the user's loyalty database 260 with coupons. For example, if the user 202 is associated with a coupon program or the like, the coupons from the coupon program may be automatically provided to the user's loyalty database 260. In other embodiments, coupons may be added to the user's loyalty database 260 by a merchant. In this way, the merchant may provide the loyalty database 260 with the coupons it has to offer users 202. The coupons that correspond to loyalty accounts held by the user 202 are then stored with the user's data in the loyalty database 260. Furthermore, coupons that are available for products that the user 202 may purchase are stored and communicated to the matching application 258 when the user 202 is entering into a transaction for that product. In this way, the user 202 may be able to utilize coupons from manufacturers, other merchants (price matching), etc. in real-time during the user's transaction with the merchant.

Finally, the loyalty database 260 stores the user's loyalty accounts and coupons together with the user's enrollment data. In this way, when the matching application 258 receives a user 202 identifier from a merchant system 206, the loyalty database 260 may be able to quickly search and find the loyalty accounts and coupons available for the user 202 to utilize during that transaction. Furthermore, the loyalty database 260 also stores coupons associated with other merchants, vendors, advertisers, manufacturers, and the like. In this way, the loyalty database 260 may determine from merchant system 206 communications, products that the user 202 is transacting for during the current transaction. The loyalty database 260 may, in turn, then be able to be searched to find and provide coupons for the products that the user 202 is transacting for that the merchant may also accept. For example, the user 202 may be purchasing Product A, Product B, and Product C from Merchant A via a P2P transaction. The loyalty database 260 may determine the user 202 is purchasing Product A and find a coupon for Product A provided by the manufacturer of Product A. If it is determined that Merchant A accepts coupons from the manufacturer of Product A, the loyalty database 260 may provide this coupon along with the user's loyalty account for Merchant A, and other coupons for Merchant A for use during the transaction.

FIG. 2 also illustrates a user device 204. The user device 204 generally includes a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server 208, the merchant system 206, and the other merchants systems 210. As such, the communication device 212 generally includes a modem, server, or other device for communicating with other devices on the network 201.

As further illustrated in FIG. 2, the user device 204 include a computer-readable instructions 220 stored in the memory device 216, which in one embodiment includes the computer-readable instructions 220 of a user application 222. In this way, a user 202 may be able to enroll in the loyalty identification matching program, add loyalty accounts, provide user 202 identifiers, and/or the like using the user application 222. In some embodiments, the memory device 216 includes data storage 218 for storing data related to the user device 204 including but not limited to data created and/or used by the user application 222. A “user device” 204 may be any communication device, such as a cellular telecommunications device (e.g., a cell phone or mobile phone), personal digital assistant (PDA), a mobile Internet accessing device, Internet accessing device, or other device including, but not limited to PDAs, pagers, televisions, gaming devices, laptop computers, desktop computer, cameras, video recorders, audio/video player, radio, Global Positioning System (GPS) devices, any combination of the aforementioned, or the like. Although only a single user device 204 is depicted in FIG. 2, the loyalty identification matching system environment 200 may include numerous user devices 204.

In some embodiments, the user device 204 allows a user 202 to enroll in the loyalty identification matching program. The enrollment may be done via an interface, the Internet, text message, voice messages, and/or the like. In this way, the user 202 may be able to provide enrollment information to the financial institution server 208 such that the user 202 may be enrolled into the loyalty identification matching program to receive loyalty account and coupons at a merchant point-of-transaction by providing a user 202 identifier to the merchant.

In some embodiments, the user 202 may use the user device 204 to add loyalty accounts. In this way, the user 202 may manually add loyalty accounts to his/her loyalty identification matching program. The user 202 may input numbers associated with the user's loyalty account, such as the account numbers. The user 202 may also scan a bar code, QR code or the like with his/her mobile device 204 to add a loyalty account associated with the bar code.

In some embodiments, the user 202 may provide the merchant and/or the merchant system 206 with the user 202 identifier to the merchant system 206. In this way, the user 202 may use text communication, voice communication, etc. the user 202 identifier to the merchant system 206 without the user 202 having to voice the user 202 identifier to the merchant. This may ensure privacy to the user 202 so that he/she may not have to provide the user 202 identifier to the merchant in a public place. In this way, the user 202 may text the user 202 identifier to the merchant system 206 via the network 201 such that the merchant system 206 may receive the user 202 identifier and subsequently communicate it to the matching application 258.

In other embodiments, the user 202 may use his/her user device 204 to initiate the P2P transaction with a merchant and/or payment receiver. In this way, the user 202 may be able to complete the entire transaction using his/her user device 204. The user device 204 may access the user's financial account through communications with the financial institution server 208 such that the user 202 may complete the P2P transaction.

The merchant system 206 or P2P recipient system generally comprises a reader device 235, a communication device 236, a processing device 238, and a memory device 240. The processing device 238 is operatively coupled to the communication device 236 and the memory device 240. The processing device 238 uses the communication device 236 to communicate with the network 201 and other devices on the network 201, such as, but not limited to the financial institution server 208, the user device 204, and the other merchants systems 210. As such, the communication device 236 generally comprises a modem, server, or other device for communicating with other devices on the network 201. Furthermore, the reader device 235 allows a merchant system 206 to determine if a user 202 is in communication with the merchant. In some embodiments, the reader device 235 may be a point-of-transaction device, a point-of-sale device, or a like device able to receive and/or process the purchase of a product at the merchant. A reader device 235 may also comprise a type of location device, such that a merchant may be able to detect a user 202 within the merchant's place of business.

As further illustrated in FIG. 2, the merchant system 206 comprises computer-readable instructions 242 stored in the memory device 240, which in one embodiment includes the computer-readable instructions 242 of a merchant application 244. In this way, in some embodiments, a merchant may be able to send user 202 identifiers, communicate with, and receive loyalty identification matching data, such as accounts and coupons from the matching application 258 of the financial institution server 208. In some embodiments, the memory device 240 includes data storage for storing data related to the merchant system 206 including but not limited to data created and/or used by the merchant application 244.

Furthermore, the merchant application 244 allows the merchant to send user 202 identifiers to the financial institution server 208, communicate with the other devices on the network 201, and receive loyalty identification matching data from the financial institution serve 208.

In some embodiments, the merchant systems 206 may send user 202 identifiers received from a user 202 to the financial institution server 208 for confirmation and loyalty account information. Next, in some embodiments, the merchant application 244 may receive loyalty identification matching data from the financial institution server 208, such that the user's loyalty account associated with that merchant may be applied to the transaction the user 202 is entering. Along with the loyalty account the user 202 has associated with the merchant, the matching application 258 may also provide coupons the user 202 has access to that are also accepted by the merchant. Furthermore, the loyalty identification matching data may also communicate with the other devices on the network 201 to provide the user 202 identifier, the products of the transaction, and other transaction information to the other systems on the network 201.

The other merchants systems 210 are operatively coupled to the financial institution server 208, the user device 204, and the merchant system 206 through the network 201. In this way, the other merchants systems 210 have systems with devices the same or similar to the devices described for the financial institution server 208, the user device 204, and the merchant system 206 (i.e., a communication device, a processing device, and a memory device). Therefore, the other merchants systems 210 communicate with the financial institution server 208, the user device 204, and/or the merchant system 206 in the same or similar way as previously described with respect to each system. The other merchants systems 210, in some embodiments, is comprised of systems and devices that allow the financial institution server 208 to access merchants information relating to loyalty accounts and coupons available through the merchants associated with the other merchants systems 210.

It is understood that the servers, systems, and devices described herein illustrate one embodiment of the invention. It is further understood that one or more of the servers, systems, and devices can be combined in other embodiments and still function in the same or similar way as the embodiments described herein.

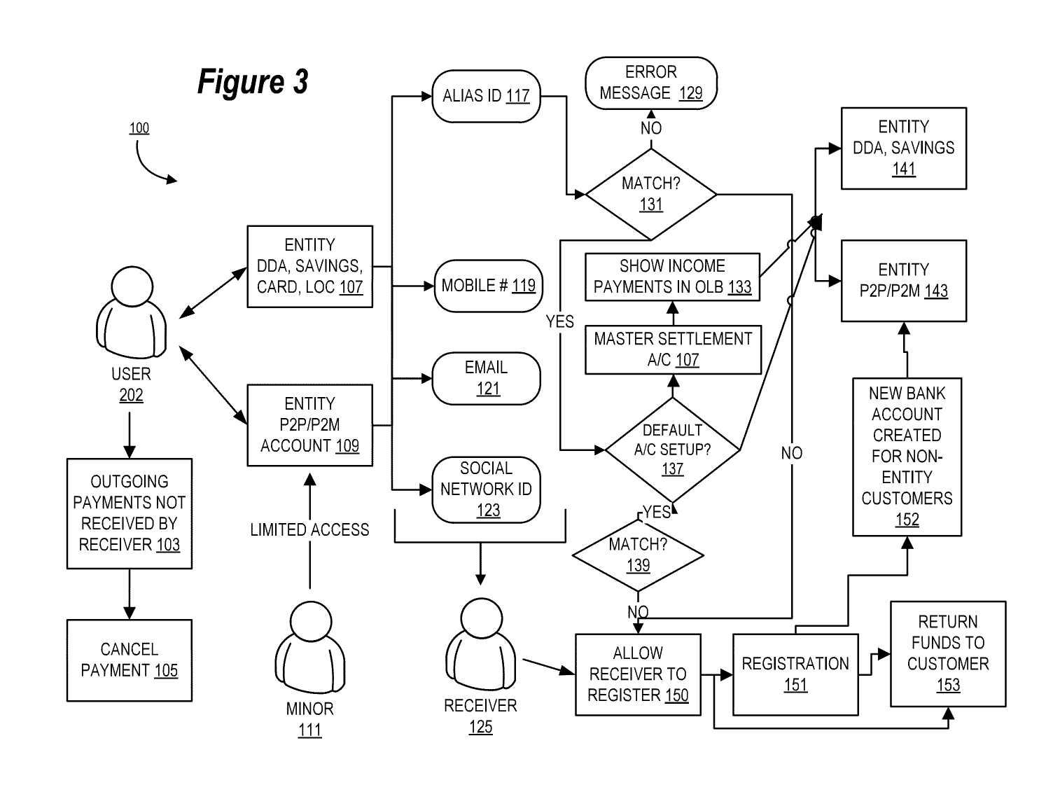

FIG. 3 illustrates a combination block diagram and flowchart providing an overview of a system and method 100 for making P2P payments, in accordance with one or more embodiments of the invention. A user 202 or non-user with an eligible account 107, e.g., checking (demand deposit account or “DDA”), savings, money market, line of credit, credit card, etc., of any financial entity is be able to register and make use of this service. During the P2P enrollment process, the user 202 is able to set up an alias identifier (ID) 117 (or simply an “alias”) that maps back to the user's account. The alias 117 may be any unique identifier other than the user's financial institution account number and may include a name, address, email address, URL address, ATM PIN number, picture, graphical art, trade name, trademark, logo, brand, or any other textual, graphical, or visual indicator. Typically, the alias 117 is an identifier that friends, family, and/or other members of the public uniquely associate with the user 202. In this way, others may send a payment to the user 202 through the use of the user's alias. For example, the alias 117 may be a mobile telephone number 119, an email address 121, a social networking ID 123, an ATM alias, a name, address, URL address, ATM PIN number, picture, graphical art, trade name, trademark, logo, brand, textual indicator, graphical indicator, visual indicator, and/or the like. The embodiments of the invention described herein in the other figures generally permit the user 202 or non-user to use either a mobile telephone number 119, ATM alias, or an email address 121 as the account alias, but it will be appreciated that, in view of this disclosure, other embodiments of the invention may allow use of other types of aliases. In another embodiment, an entity may provide information to the P2P transaction, such that the entities account information may be pre-established within the P2P transaction. Typically these entities may include, but are not limited to, merchants, retailers, service providers, etc. In this way, the user 202 may use aliases to send payments to other individuals and use pre-established entities to send payments to merchants and the like.

The information provided by the user 202 during enrollment of an alias may be verified to confirm that the user 202 does have access to the alias. For example verification of an ATM PIN number or the like. In yet another example, the financial institution (or other entity that maintains a database of aliases and associates them with financial institution accounts) may send a communication to the user 202 using the alias and require the user 202 confirm access to the alias by responding to the notice in some way. For example, if the alias registered by the user 202 is a telephone number 119, the financial institution may send a message to the telephone number 119 with a code and then require that the user 202 enter the code into an interface to confirm that the telephone number is associated with the user 202. Once the alias information is verified, then the alias is linked to one or more of the user's financial institution accounts in a data repository maintained by the financial institution or some other entity that provides an alias registry service to the financial institution.

The user 202 can also use embodiments of the invention to make payments to other entities. Payments to other entities may occur by using an alias of the receiver 125 or the name of the receiver 125 entity, if the receiver 125 has pre-established an account with the P2P payment system. In some embodiments of the invention, the user 202 is able to set preferences for accounts to be used for outgoing payments, and default account(s) for incoming payments. In some embodiments of the invention, the financial institution places limits (e.g., maximums and/or minimums) on how much money can be sent or received over a specified period of time using P2P payment aliases, and such limits may be based on the sender, the receiver, whether the receiver is a user of the financial institution or a partner financial institution, account history, credit ratings, user status, whether the user has registered the alias, user 202 loyalty accounts, information regarding user 202 enrollment into the loyalty identification matching program, user 202 coupons, and/or any other relevant information. In some embodiments, the user 202 can also establish limits on P2P payments. For example, a user 202 may want to set a maximum of $1000 for P2P payments where an alias is used for the receiver as opposed to an account number.

In some embodiments of the invention, the user 202 may also have an option of opening a new P2P account 109 with the financial institution that the user may use exclusively for making and/or receiving P2P payments. This financial entity P2P account 109 may be like any other account hosted at the financial entity and so money may be moved instantly into this account 109 through the regular process for moving money between a user's accounts. This account 109 may be a type of checking account except that it may come with certain limitations, e.g., no checks, maximum balance limits, number of daily transactions or the like, and may be opened by users by providing much less information as compared to a regular checking account. The financial entity may, at a minimum, require users to provide certain information, such as name, address, date of birth, and social security number, in order to comply with Anti-Money Laundering (AML) regulations. Users 202 of the financial entity may also have an option to set up P2P accounts 109 (i.e., sub-accounts) for minors 111, other dependents, or related entities. Users 202 are able to access these accounts just like any of their other accounts. In addition, users 202 are able to set up an ATM access ID for the minor 111 that the minor 111 may utilize the user's P2P transactions, but have access only to the specific minor P2P account 109 set up for them.

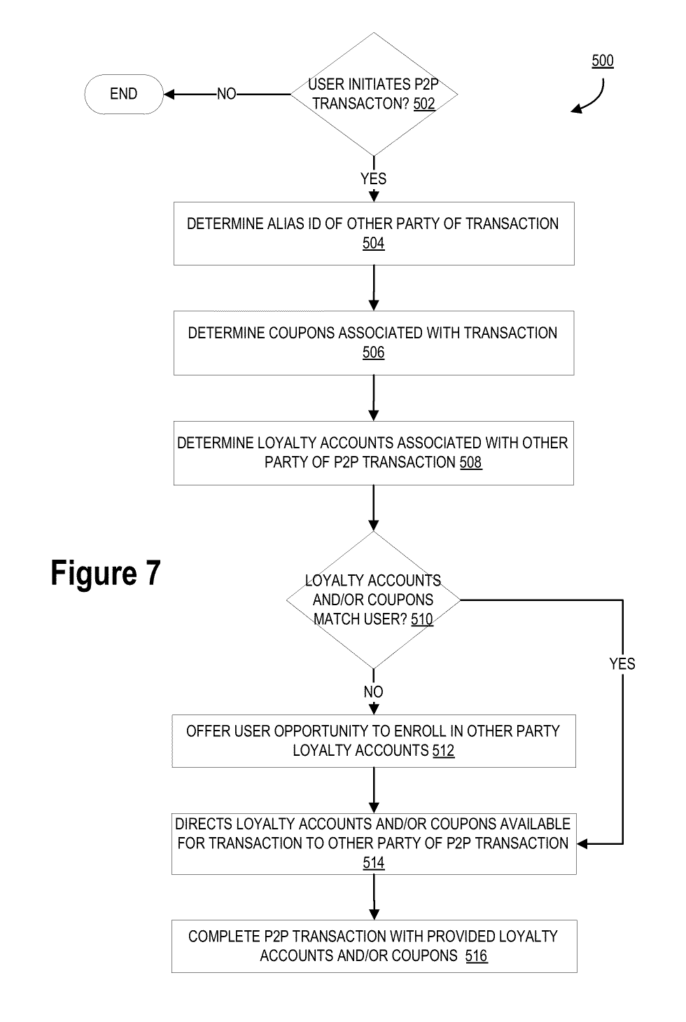

Referring again to FIG. 3, users 202 are able to make payments to other people through any of a number of different methods. In one such method the user 202 may select an entity from a pre-established list of entities. The pre-established entities may include, but are not limited to, merchants, retailers, service providers, individuals, etc. The pre-established entities may provide information to the system, such that the system may recognize the accounts associated with the entity. The user 202 may select the entity, based on the entities name, such as Merchant A, from an interface or the like. The selection of the entity name may be attached to an account for the entity. In this way, the entity may have provided account information and the like to the financial institution, such that the financial institution has access to the account, etc. to use in the P2P transaction. Therefore, the user 202 may select the entity's name, such as Merchant A. Once the user 202 selected the entity, the user 202 may direct payment to the entity via the P2P transaction. If the entity pre-established a relationship with the financial institution and the user 202 provided P2P payment to the entity an error will not occur because the entity has pre-established a relationship with the financial institution and the P2P program. Therefore, the entities may not need to provide alias information or confirmation for the alias. In this way, the user 202 may be able to send payments to the entity directly without any delay. During this P2P transaction with a pre-established entity, the system may determine loyalty accounts and/or coupons that the user 202 may be able to utilize for the P2P transaction with the entity. This process is further detailed below with respect to FIG. 7.

In accordance with embodiments of the invention, payments may be made by providing an alias 117. In general, the user 202 initiates a P2P payment using an alias by communicating an alias for the receiver 125 and an associated payment amount to the financial institution. The financial institution then accesses an alias database, or other type of data repository, to determine if the entered alias 117 has been registered by the alias holder and is, thereby, associated with a particular financial institution account. If the alias 117 does have a match 131 to another user 202 or financial institution account of another user 202, then the payment may be initiated to that person through the financial institution offering the P2P program. If there is no match, then either an error message 129 is generated or, if possible, the alias 117 may be used to contact the intended receiver 125 and allow this person to register the alias 117 and thereby associate the alias with a financial institution account, at block 150. At any time, if outgoing payments or payment notifications are not received by a receiver (as represented by block 103), the payment may be canceled (as represented by block 105).

In some embodiments of the invention, an alias 117 may be associated with multiple financial institution accounts of the alias holder. In some such embodiments, the alias holder may be able to establish a default account when registering the alias 117 or afterwards. Consequently, if a receiver 125 does have a default account for incoming payments in 137, then the funds may be transferred instantly to that account(s). If the receiver 125 has not set up a default account in 137 but the receiver 125 does have multiple accounts associated with the alias 117, then the funds may be moved to a master settlement account 135 and the receiver 125 may see the payment as an incoming payment within online banking 133. The receiver 125 may then be able to use the online banking application to move the funds instantly to any of the receiver's others accounts. In other embodiments, however, each alias 117 is associated only with one financial institution account and, therefore, steps 137 and 135 are not needed and the payment is deposited directly into the one financial institution account associated with the alias 117.

As further illustrated in FIG. 3, the alias 117 may be a telephone number 119 and, as such, payment may be made by the user 101 providing a telephone phone number 119 (the telephone number 119 being the telephone number of the intended payment receiver 125) along with an associated payment amount onto his/her user device 204. This operation may perform exactly as described above for the alias 117 if there is a match in 139. If there is no match in 139, then a message may be sent to the receiver (as represented by block 150). If the receiver 125 of the message is an existing financial institution user (or, in some embodiments, if the receiver 125 is a user 202 of a partner financial institution), then that person may be allowed to sign into the P2P payment system and register an alias for the P2P transaction as illustrated by block 151 (thereby associating the phone number with a financial institution account for P2P payment purposes), and then receive funds similar to the process described above for the alias 117. If the receiver 125 is not a financial institution customer with an account eligible for receiving funds, then the receiver 125 may be given the option to sign up (as represented by block 152) for a financial institution account 141 or 143 at the financial institution or return funds to the sender (as represented by block 153). Furthermore, the receiver 125 may be offered to sign up to provide its loyalty account users to the system, such that the system may be able to determine other users 202 that may have loyalty accounts with that P2P payment receiver 125.

As further illustrated in FIG. 3, the alias 117 may be an email address 121 and, as such, payment may be made by the user 202 providing an email address 121 (the email address 121 being an email address of the intended payment receiver 125) along with an associated payment amount. This operation may perform exactly as described above for a mobile number 119 except that the notification message (with the registration or account opening option if appropriate) is sent to the email address 121 provided.

In some embodiments of the invention, payment may be made by providing a social networking ID 123, such as a unique ID associated with the receiver 125 on a particular social networking Internet site. In such a situation, the process operates in the same way as described above for mobile phone number 119 and email address 121 except the social networking platform may be used to notify the receiver based on the social networking ID 123 provided.

In all cases described above, if the receiver 125 is already a user 202 of the P2P program and thus has already registered the alias 117 provided by the user 202, a text message, email, online banking notice, mobile banking notice, ATM notification, or other type of message may be sent to receiver 125 based on the alias 117 entered by the user 202 or irrespective of information entered by sender if there is other contact information found in the receiver's profile, the notification notifying the receiver 125 of the payment. In some embodiments, the receiver 125 may be allowed to reject or re-route the payment. In some embodiments of the invention, the user 202 is permitted to include a note to the receiver 125 along with the payment, such as a note explaining to the receiver what the purpose of payment.

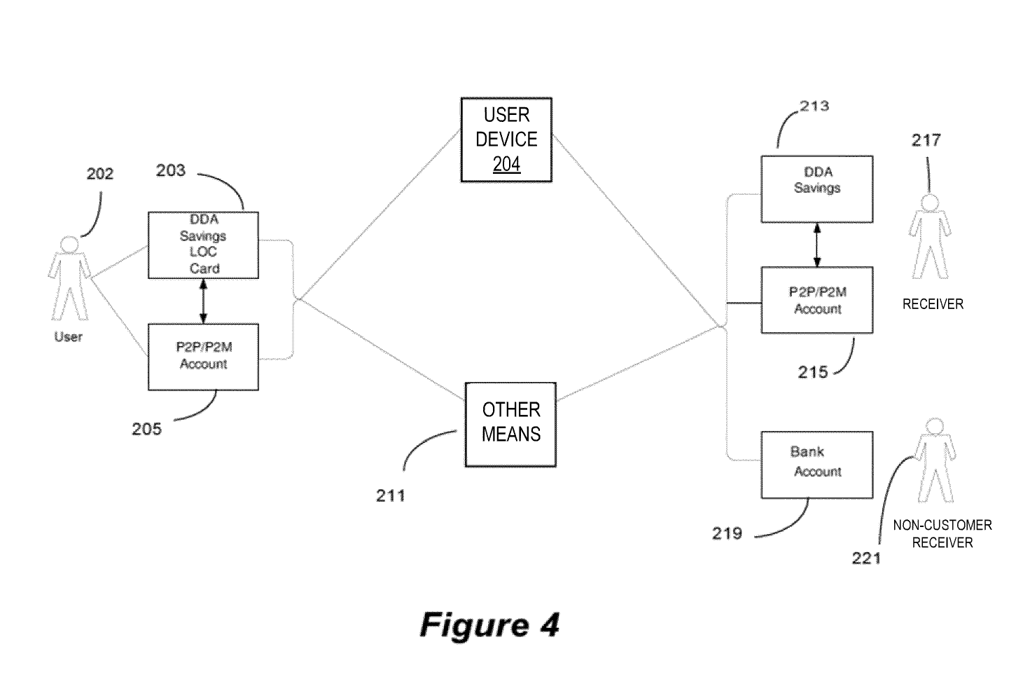

FIG. 4 illustrates a block diagram illustrating the various ways through which a user 202 may make P2P payments in accordance with various embodiments of the invention. As illustrated, in some embodiments of the invention, a user 202 who is signed up for the P2P payment service and/or the loyalty identification matching program has the option to initiate P2P payments from a DDA, savings, line of credit, and/or credit card account 203 of the financial entity (and/or from a P2P-specific account 205 with the financial entity) through the user device 204 by providing an alias ID along with a payment amount. In some embodiments, a user 202 can alternatively or additionally use other means 211, such as, but not limited to the financial institution's ATM, computer, telephone, merchant device, etc. to initiate a payment using an alias or a pre-selected P2P payment entity. Whether via a user device 204 or other means 211, a receiver 217 associated with a financial institution may receive funds at the receiver's financial institution account (e.g., DDA, savings, or credit account 213 or P2P-specific account 215). A receiver not associated with the financial entity 221 may receive funds at the receiver's financial institution account 219 at another partner financial institution if the account is registered and associated with the alias and/or the receiver 221 may be prompted to register for the service and/or open an account with the financial institution in order to receive the payment from the sender user 202.

It should be appreciated that embodiments of the invention described above permit an entity to send money to another entity even if the sending entity does not know any account information for the receiver entity and only knows a P2P alias ID of the receiver entity or the receiver entity is pre-established to receive payments via the P2P program. This can also result in better protection of personal account information. It should also be appreciated that some embodiments of the invention create a viral registration and/or account opening system that allows for users 202 of a financial institution to send payments to anyone outside the financial entity using an alias. In such embodiments, the non-users are contacted using the alias and they are allowed to quickly open and/or register an account with the financial institution in order to receive the funds from the sender.

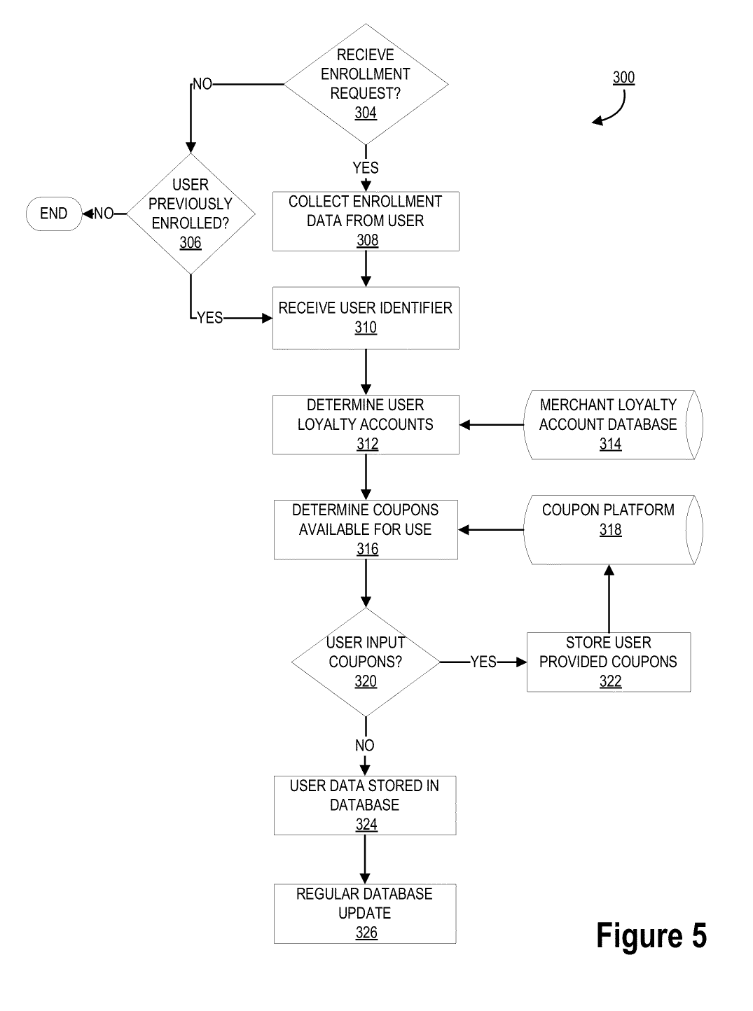

FIG. 5 illustrates a flow chart of the process of population of the loyalty identification matching program system 300, in accordance with one embodiment of the present invention. The flow chart illustrates one embodiment of the flow of data throughout the system. As illustrated in decision block 304, the system determines if an enrollment request has been received. The enrollment request may be received from a user 202, through various means, including, but not limited to, an interface, P2P transaction interface, paper, Internet, via the user device 204, at a financial institution, at a merchant, and/or the like. If the system determines that an enrollment request was received in decision block 304 then the system will collect enrollment data from the user 202, as illustrated in block 308. A user 202 may enroll in several ways, including, but not limited to manual enrollment, automatic enrollment, secondary enrollment based on enrollment in other programs, and/or the like. In some embodiments, the system may allow a user 202 to enroll into the loyalty identification matching program by inputting his/her enrollment data into an enrollment form. The enrollment form may be accessed through the user's online banking, mobile banking, the Internet, at a merchant, at a financial institution, and/or the like. The user 202 may complete the enrollment form using his/her user device 204, hand writing etc. This enrollment data provided by the user 202 may then be collected by the system, as illustrated in block 308.

Referring back to decision block 304, if no enrollment request has been received the system may, as illustrated in decision block 306, determine if the user 202 has previously enrolled in the loyalty identification matching program and/or has been automatically enrolled based on other programs the user 202 is enrolled in. In some embodiments, the user 202 may have previously enrolled in the loyalty identification matching program, as such the system has the user's enrollment data and does not have to collect the data again. In other embodiments, the user 202 may automatically be enrolled in the loyalty identification matching program. Automatic enrollment may be based on other programs the user 202 is enrolled in. In this way, the user 202 may be automatically enrolled in the loyalty identification matching program in conjunction with other programs, such as, but not limited to P2P transaction programs, loyalty programs, rewards programs, coupon programs, merchant provided programs, financial institution provided programs, etc.

If it is determined that the user 202 has not previously enrolled in the loyalty identification matching program or in another program the process may end there. However, if a previous enrollment is discovered in decision block 306 the system then may receive a user 202 identifier, as illustrated in block 310. The user 202 identifier may be selected by the user 202 to provide to a merchant for the loyalty identification matching program. The user 202 identifier may include, but is not limited to, the user's P2P alias ID, phone number, PIN number, password, passcode, etc. In this way, the system may recognize the user 202 identifier based on the user's enrollment data. The system may be provided the user 202 identifier from a merchant that the user 202 is currently wishing to transact via P2P with. Once the user 202 identifier has been received in block 310, the system may determine all the loyalty accounts the user has, as illustrated in block 312. The loyalty accounts of a user 202 may be determined using several means, including, but not limited to, searching previously stored user loyalty accounts, communicating with merchants to determine if the user 202 has loyalty accounts with that merchant, and/or receiving loyalty accounts from the user 202. In some embodiments, previously discovered loyalty accounts may be stored in a merchant loyalty account database 314. The merchant loyalty account database 314 stores loyalty accounts for users 202 that the system has received from the user 202 or from merchants. The loyalty accounts in the merchant loyalty account database 314 are stored with the user's enrollment data such that the loyalty accounts may be associated with the user 202 and the user's identifier.

Next, as illustrated in block 316, coupons that the user 202 has available for use for a transaction are determined. Coupons available to the user 202 may include, but are not limited to, coupons the user 202 inputted into the loyalty identification matching program, merchant coupons, coupons from various coupon programs, rewards coupons, etc. Coupons available to the user 202 may be stored in a coupons platform 318. The coupon platform 318 stores coupons associated with the user's loyalty accounts. In this way, the coupons match to the various loyalty accounts the user 202 has. For example, if the user 202 has loyalty accounts for Merchant A and Merchant B but not for Merchant C, the coupons available to the user 202 that are stored in the coupon platform 318 are only those coupons that are accepted at Merchant A and Merchant B, not coupons only accepted at Merchant C. In this way, when the user 202 enters into a transaction, the system may determine the merchant, provide the user's loyalty account information to that merchant, and also provide any coupons the user 202 may have available to use for a transaction with that merchant.

The coupons stored in the coupon platform 318 include any offers, promotions, coupons, sales, rewards points, special offers, etc. that the user 202 may have for that merchant. These coupons may be received from the merchant, a manufacturer of products, advertisers, the user 202, etc. In this way, the coupons available for the user may also include product specific or transaction specific coupons. Therefore, the system may continually monitor the user's transaction and determine if there are coupons available for the products of the transaction. For example, a user 202 may have provided Merchant A with his/her user 202 identifier. The user 202 may then be in the process of a transaction with Merchant A. During the transaction the system monitors the products being purchase and determines if the user 202 has coupons available for those products. For example, if the user 202 is purchasing Product A, Product B, and Product C, the system may determine that the manufacturer of Product B has a coupon that is accepted by Merchant A. The system then provides Merchant A with that coupon along with the user's loyalty account prior to the transaction being complete, such that the coupon for Product B and the user's loyalty account may be applied to the transaction.

In some embodiments, the user 202 may input coupons into the loyalty identification matching program, as illustrated in decision block 320. If the user 202 does decide to input coupons in decision block 320 the user 202 inputted coupons are then stored in the coupon platform 318 with the other coupons available for the user 202. In some embodiments, the user 202 may input coupons prior to a transaction with a merchant. In some embodiments, the user 202 may input coupons during the transaction with a merchant. If the user 202 does not decide to input coupons, the process continues.

Next, as illustrated in block 324 all of the user 202 data is stored together in a database. In this way, the user 202 enrollment data, the user 202 loyalty accounts, and the coupons available to the user 202 are all stored in association with the user's identifier. In this way, when a merchant sends a user identifier to the system, the system may quickly search and find all loyalty accounts and coupons the user 202 may have and provide them to the merchant. Finally, as illustrated in block 326, the system regularly updates the user database. In this way, loyalty accounts that the user 202 recently signed up for, recent merchant coupons, etc. may be available to the whenever the user 202 is entering into a P2P transaction.

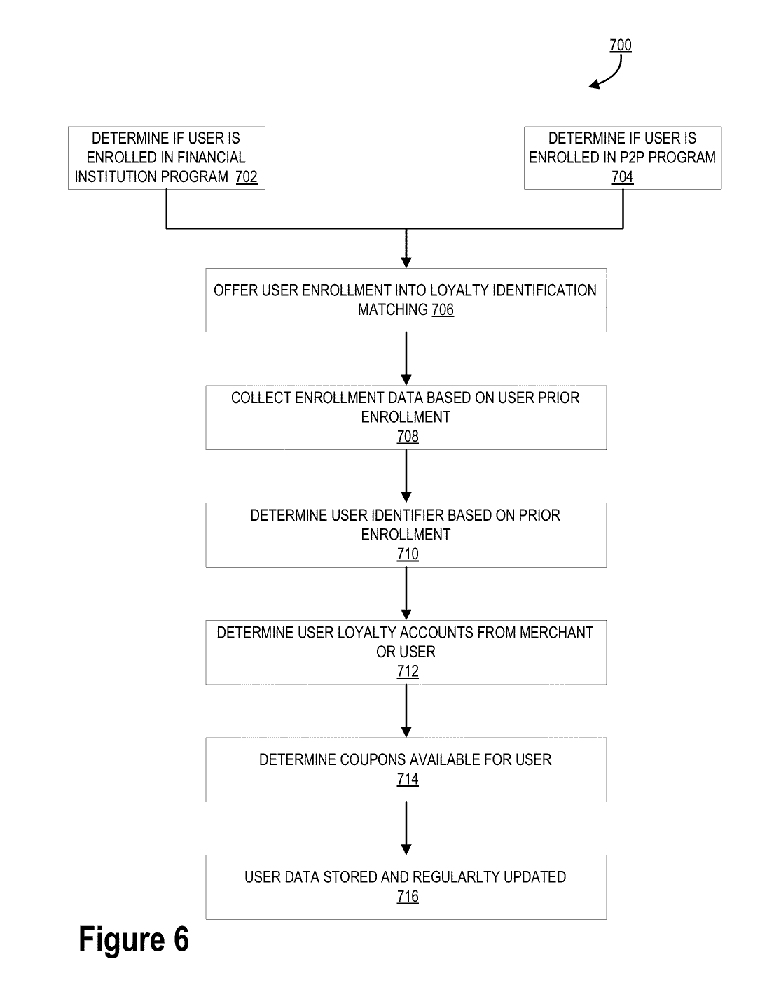

FIG. 6 illustrates a process map of populating of the loyalty identification matching program system 700, in accordance with one embodiment of the present invention. First, the system may determine if the user 202 has enrolled in programs other than the loyalty identification matching program, such as a financial institution program or merchant program. As illustrated in block 702 the system may determine if the user 202 is enrolled in a financial institution program 702. A financial institution program may include any program, such as accounts, savings programs, budgeting programs, etc. that a financial institution providing the loyalty identification matching program. Next, as illustrated in block 704, the system may determine if the user 202 is enrolled in a P2P payment program. In this way, the user 202 will be able to utilize the loyalty identification matching program during a P2P transaction. Using the loyalty identification matching program for P2P is discussed further below with respect to FIG. 7. Furthermore, the system may determine if the user 202 has enrolled in a merchant program, such as rewards accounts, merchant coupon programs, and/or the like.

After the system determines whether the user 202 has previously enrolled in a financial institution program, a P2P program, and/or a merchant program, the system may then offer the user 202 enrollment into the loyalty identification matching program, as illustrated in block 704. In some embodiments, the system may automatically enroll the user 202 in the loyalty identification matching program when it is determined that the user 202 has previously enrolled in a financial institution program, a P2P program, and/or a merchant program. In other embodiments, the system may, as illustrated in block 706 offer the user 202 enrollment in to the loyalty identification matching program. In some embodiments, the user 202 may be offered enrollment into the loyalty identification matching program without the user 202 being enrolled in a prior program.

If the user 202 selects enrollment from the enrollment offer illustrated in block 706, the system may then collect user 202 enrollment data based on the user's prior enrollment in a financial institution program, a P2P program, and/or a merchant program. Although a user 202 may be able to provide enrollment without previously enrolling in a program, this embodiment utilizes the data from previous enrollment in programs to determine the required enrollment information for the loyalty identification matching program. Next, based on the prior program enrollment the system may determine the user 202 identifier, as illustrated in block 710. In this way, the system may determine an alias ID, phone number, PIN number, password, etc. that a user 202 may use for the loyalty identification matching program. Next, once the user 202 has enrolled, the system may determine loyalty accounts from a merchant and/or user inputs, as illustrated in 712. Next, once the loyalty accounts are determined, the system determines coupons available for the user 202, as illustrated in block 714. The coupons may be determined based on the loyalty accounts the user 202 has enrolled in, merchant provided coupons, previously enrolled in coupon and/or rewards programs, etc. Finally, as illustrated in block 716, the user data is stored and regularly updated. In this way, the enrollment data from the user's previous program enrollment, the user's loyalty accounts determined, and the coupons available for the user 202 are all stored together, such that the system may easily access the user's loyalty accounts and coupons based on the user's identifier.

FIG. 7 illustrates a process map of the loyalty identification matching program being used for a P2P transaction 500, in accordance with one embodiment of the present invention. First, the system determines if the user 202 is initiating a P2P transaction, as illustrated in decision block 502. A P2P transaction may allow a user 202 to send and/or receive funds using a P2P alias ID as described in further detail above with respect to FIGS. 3 and 4. In this way, the user 202 may direct funds from an account using his/her user device 204 or other means, such as an ATM, computer, television, etc. to a funds receiver, such as a person, merchant, and/or other entity. The system may determine from the alias the accounts associated with the payer and the receiver and direct funds from the accounts associated with the aliases. In this way, the user 202, whether a payer or a receiver may be able to transfer funds without having to provide personal identifiable information, such as a credit card number, social security number, account number, and/or the like. If it is determined that a user 202 is not initiating a P2P transaction, this process is terminated.

Once it is determined that a user 202 is initiating a P2P transaction, as illustrated in decision block 502, the system may determine the alias identification of the other party of the transaction, as illustrated in block 504. In this way, the system may, from the alias identification determine the entity, such as a person and/or merchant associated with the alias. From there, the system may determine coupons that the user 202 may use for the transaction with the other party of the P2P transaction or the payment receiver, as illustrated in block 506. Furthermore, the system may determine loyalty accounts that may be associated with the alias of the payment receiver of the P2P transaction, as illustrated in block 508. In this way, based on the payment receiver's alias, the system may determine the loyalty accounts and/or the coupons that the other party of the P2P transaction may accept.

Once the system determines the loyalty accounts and/or coupons that the other party of the P2P transaction may accept, the system determines in decision block 510 if the accepted loyalty accounts and/or coupons match the user 202 transacting with the other party in the P2P transaction. If the system determines that the loyalty accounts and/or coupons accepted by the other party in the P2P transaction are not ones that the user 202 has access to, the system may offer the user 202 the opportunity to enroll in the other party of the P2P transaction loyalty accounts, as illustrated in block 512. In some embodiments, the user 202 may select to be enrolled in the loyalty programs accepted by the other party of the P2P transaction. In other embodiments, the user 202 may automatically be enrolled in the loyalty program accepted by the other party of the P2P transaction.

Next, if the user 202 accepts the opportunity to enroll in the other party of the P2P transaction loyalty accounts, as illustrated in block 512 or if it is determined in decision block 510 that the loyalty accounts and/or coupons the other party of the P2P transaction accepts matches ones the user 202 has, then as illustrated in block 514 the system directs the loyalty accounts and/or coupons available for the transaction to the other party of the P2P transaction. Finally, as illustrated in block 516, once the loyalty accounts and/or coupons are directed to the P2P transaction, the P2P transaction may be completed using the loyalty accounts and/or coupons provided to the other party of the P2P transaction by the system.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that all computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the all computer-executable program code portions for carrying out operations of embodiments of the present invention are written in conventional procedural programming languages, such as the “C” programming languages and/or similar programming languages. The computer program code may alternatively or additionally be written in all multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by all computer-executable program code portions. These all computer-executable program code portions may be provided to a processor of a general purpose computer, special purpose computer, and/or some other programmable data processing apparatus in order to produce a particular machine, such that the all computer-executable program code portions, which execute via the processor of the computer and/or other programmable data processing apparatus, create mechanisms for implementing the steps and/or functions represented by the flowchart(s) and/or block diagram block(s).

It will also be understood that the all computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The all computer-executable program code portions may also be loaded onto a computer and/or other programmable data processing apparatus to cause a series of operational steps to be performed on the computer and/or other programmable apparatus. In some embodiments, this produces a computer-implemented process such that the all computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing loyalty account information for a person-to-person transaction, the system comprising:
a memory device with computer-readable program code stored thereon;
a communication device;
a processing device operatively coupled to the memory device and the communication device, wherein the processing device is configured to execute the computer-readable program code to:
receive a user alias identification from a user, wherein the user is initiating a person-to-person transaction with a second party utilizing the user alias;
determine loyalty accounts associated with the user, wherein the loyalty accounts are determined by communicating with merchants providing the loyalty accounts, wherein the loyalty accounts are stored in association with the user alias identification;
determine an alias identification for the second party of the person-to-person transaction;
determine if the loyalty accounts associated with the user alias identification received from the user are accepted by the entity associated with the alias identification for the second party of the person-to-person transaction; and
provide the second party of the person-to-person transaction with the loyalty accounts accepted by the second party of the person-to-person transaction, such that the loyalty accounts can be applied to the person-to-person transaction.

2. The system of claim 1 further comprising:
determining coupons available to the user;
storing the coupons in association with the user identifier and the loyalty accounts;
determining coupons that the second party of the person-to person transaction accepts; and
providing the second party with the coupons acceptable by the second party in association with the loyalty accounts accepted by the second party, such that the coupons and loyalty accounts can be applied to the transaction with the second party.

3. The system of claim 1, wherein the user alias identification is associated with a financial account of the user, such that the financial account is used for payment to the second party in the person-to-person transaction.

4. The system of claim 1 further comprising processing the person-to-person transaction such that a payment is transferred from the financial account associated with the user alias identification to a financial account associated with the second party of the person-to-person transaction.

5. The system of claim 1, wherein the second party is a receiver of a person-to-person payment made by the user via the person-to-person transaction, wherein the second party is a merchant.

6. The system of claim 1, wherein determining loyalty accounts associated with the user further comprises one or more of automatically determining the loyalty accounts associated with the user upon user enrollment into a person-to-person transaction program or receiving loyalty account information from the user.

7. The system of claim 2, wherein determining coupons available to the user further comprises one or more of receiving coupons from a merchant offering the coupons or receiving coupons from the user.

8. The system of claim 1 further comprising providing automatic enrollment in one or more loyalty accounts associated with the second party of the person-to-person transaction if no loyalty accounts associated with the user alias identification are accepted by the second party.

9. The system of claim 1, wherein the person-to-person transaction is one or more of a person-to-person, person-to-merchant, or person-to-entity transaction.

10. A computer program product for providing loyalty account information for a person-to-person transaction, the computer program product comprising at least one non-transitory computer-readable medium having computer-readable program code portions embodied therein, the computer-readable program code portions comprising:
an executable portion configured for receiving a user alias identification from a user, wherein the user is initiating the person-to-person transaction utilizing the user alias with a second party;
an executable portion configured for determining loyalty accounts associated with the user, wherein the loyalty accounts are determined by communicating with entities providing the loyalty accounts, wherein the loyalty accounts are stored in association with the user alias identification;
an executable portion configured for determining an alias identification for the second party of the person-to-person transaction;
an executable portion configured for determining if the loyalty accounts associated with the user alias identification received from the user are accepted by the entity associated with the alias identification for the second party of the person-to-person transaction; and
an executable portion configured for providing the second party of the person-to-person transaction with the loyalty accounts accepted by the second party of the person-to-person transaction, such that the loyalty accounts can be applied to the person-to-person transaction.

11. The computer program product of claim 10, wherein the computer-readable program code portions further comprise:
an executable portion configured for determining coupons available to the user;
an executable portion configured for storing the coupons in association with the user identifier and the loyalty accounts;
an executable portion configured for determining coupons that the second party of the person-to person transaction accepts; and
an executable portion configured for providing the second party with the coupons acceptable by the second party in association with the loyalty accounts accepted by the second party, such that the coupons and loyalty accounts can be applied to the transaction with the second party.

12. The computer program product of claim 10, wherein the user alias identification is associated with a financial account of the user, such that the financial account is used for payment to the second party in the person-to-person transaction.

13. The computer program product of claim 10 further comprising an executable portion configured for processing the person-to-person transaction such that payment is transferred from the financial account associated with the user alias identification to a financial account associated with the second party of the person-to-person transaction.

14. The computer program product of claim 10, wherein the second party is a receiver of a person-to-person payment made by the user via the person-to-person transaction, wherein the second party is a merchant.

15. The computer program product of claim 10, wherein determining loyalty accounts associated with the user further comprises one or more of automatically determining the loyalty accounts associated with the user upon user enrollment into a person-to-person transaction program or receiving loyalty account information from the user.

16. The computer program product of claim 11, wherein determining coupons available to the user further comprises one or more of receiving coupons from a merchant offering the coupons or receiving coupons from the user.

17. The computer program product of claim 10 further comprising an executable portion configured for providing automatic enrollment in one or more loyalty accounts associated with the second party of the person-to-person transaction if no loyalty accounts associated with the user alias identification are accepted by the second party.

18. The computer program product of claim 10, wherein the person-to-person transaction is one or more of a person-to-person, person-to-merchant, or person-to-entity transaction.

19. A method for providing loyalty account information for a person-to-person transaction, the method comprising:
receiving a user alias identification from a user, wherein the user is initiating the person-to-person transaction utilizing the user alias with a second party;
determining loyalty accounts associated with the user, wherein the loyalty accounts are determined by communicating with merchants providing the loyalty accounts, wherein the loyalty accounts are stored in association with the user alias identification;
determining an alias identification for the second party of the person-to-person transaction;
determining, by a computer device processor, if the loyalty accounts associated with the user alias identification received from the user are accepted by the entity associated with the alias identification for the second party of the person-to-person transaction; and
providing the second party of the person-to-person transaction with the loyalty accounts accepted by the second party of the person-to-person transaction, such that the loyalty accounts can be applied to the person-to-person transaction.

20. The method of claim 19 further comprising:
determining coupons available to the user;
storing the coupons in association with the user identifier and the loyalty accounts;
determining coupons that the second party of the person-to person transaction accepts; and
providing the second party with the coupons acceptable by the second party in association with the loyalty accounts accepted by the second party, such that the coupons and loyalty accounts can be applied to the transaction with the second party.

21. The method of claim 19, wherein the user alias identification is associated with a financial account of the user, such that the financial account is used for payment to the second party in the person-to-person transaction.

22. The method of claim 19 further comprising processing the person-to-person transaction such that a payment is transferred from the financial account associated with the user alias identification to a financial account associated with the second party of the person-to-person transaction.
